(19) United States
(12) Patent Application Publication
(10) Pub. No.: US 2008/0126464 A1
(43) Pub. Date: May 29, 2008

(54) LEAST SQUARE CLUSTERING AND FOLDED DIMENSION VISUALIZATION

(76) Inventor: Shahin Movafagh Mowzoon, Chandler, AZ (US)

Correspondence Address: QUARLES & BRADY LLP, RENAISSANCE ONE, TWO NORTH CENTRAL AVENUE, PHOENIX, AZ, 85004-2391, US

(21) Appl. No.: 11/772,814

(22) Filed: Jul. 2, 2007

Related U.S. Application Data
(60) Provisional application No. 60/806,430, filed on Jun. 30, 2006.

(51) Int. Cl. G06F 7/60; G06F 7/38

(52) U.S. Cl. 708/442

(57) ABSTRACT

A two dimensional rendition of a multi-dimensional data set is presented wherein the multi-dimensional data set is graphed on a coordinate system having axes that are a predetermined angle away from each other axes in the coordinate system. Each subsequent predetermined angle may be half the previous predetermined angle for the series of coordinate axes. Additionally a clustering approach is presented that clusters the solution vectors of the data thereby combining elements of regression with clustering and reducing the dimensionality of the data to be clustered while allowing the clustering to be done against a set of reference vectors or data.

### CROSS-REFERENCE TO RELATED APPLICATIONS

This application is a utility claims priority to, the U.S. Provisional Patent Application Ser. No. 60/806,430, by Shahin Movafagh Mowzoon filed on Jun. 30, 2006, titled “SEMI-SUPERVISED SOLUTION SPACE CLUSTERING,” the entire contents of which is hereby incorporated by reference.

### FIELD OF THE INVENTION

This invention relates in general to data analysis, more specifically to the fields of Multivariate Analysis or Data Mining and can be applicable where there is large amounts of data can be clustered or grouped. In one implementation, data with many dimensions can be visualized using a two dimensional graph.

### BACKGROUND

### Data Objects

Data stored on a computer is often represented in form of multidimensional objects or vectors. Each of the dimensions of such a vector can represent some variable. Some examples are: count of a particular word, intensity of a color, x and y position, signal frequency or magnitude of a waveform at a given time or frequency band.

### Supervised and Unsupervised Learning Techniques

In Data mining, or Multivariate Analysis, supervised learning involves using models or techniques that get “trained” on a data-set and later are used on new data in order to categorize that new data, predict results or create a modeled output based on the training and the new data. Supervised techniques often may need an output or response variable or a classification label to be present along with input variables. However, in unsupervised learning methods no response variable is needed, it is more of an exploratory technique where variables are inputs and the data is usually grouped by distance or dissimilarity functions using various algorithms and methods.

Clustering is the key method for unsupervised learning. Its strength lies in its ability to group data into a flexible set of groups with no requirements for training or an output variable. The hierarchical method of “agglomerative clustering” and the partitioning method k-means are the most common clustering techniques and are found in most statistical software packages. Additional types of clustering would include density-based methods, grid-based methods, model-based methods, high-dimensional data clustering methods and constraint-based methods.

In the k-means partitioning method, for example, given k number of partitions, the k-means partitioning method constructs k initial partitions then uses the Euclidean distance metric to group data into each partition, it then recalculates the mean for each partition and iterates again relocating the data based on the new mean values, it continues iterations until the mean values for the partitions stop changing. Different initial partitions may result different local minima and thus different results.

Hierarchical methods can be either agglomerative or divisive. The agglomerative method is a bottom-up method as it starts with each single data point in its own cluster and joins the closest points or groups iteratively based on the distance functions until a single cluster is formed. There are variations on how the algorithm decides to join the objects, these linkage variations look at distances between the objects and may use nearest, farthest, average or combinations of such distances or other criterion such as Ward's measures of variance to determine the next grouping. The divisive method is a top-down approach where it starts from all the data in a single cluster and continues dividing until each data point is in its own cluster.

There are disadvantages to clustering methods. For example, clustering methods often have the disadvantage of dimensionality where too many dimensions can often make the data sparse and the distance measures less meaningful. Moreover, the number of clusters is commonly one of the inputs in most algorithms and it is often difficult to determine how many clusters is the right number of clusters to generate without some problem domain knowledge.

Supervised learning techniques such as decision trees, support vector machines and artificial neural networks are very powerful techniques but need a training step using a given

Therefore, it would be useful to be able to analyze trends in data and visually represent multiple dimension data in a way that minimizes the above mentioned disadvantages. Namely, it would be useful to have a clustering technique that properly combines the strengths of both regression and clustering techniques based on solid mathematical principals in a way that does not depend on a model training step.

### SUMMARY

Implementations include rendering a two-dimensional visual representation of a multi-dimensional data set. A method includes receiving an input variable having multiple dimensions in a first coordinate system, using an algorithm to convert the input variable from the first coordinate system to a second coordinate system and rendering a two-dimensional visual representation of the input variable using the second coordinate system, wherein the second coordinate system has a series of coordinate axes in a single plane each located at a corresponding predetermined angle away from each of the other coordinate axes of the second coordinate system. The series of coordinate axes may be such that an axis in the series of coordinate axes is one-hundred-and-eighty degrees from the zero (e.g., “−x axis”), the next axis in the series of coordinate axes may be ninety degrees from zero (e.g., “y axis”), the next axis in the series of coordinates axes may be at forty-five degrees from zero (e.g., “z axis”), and each additional axis in the series of coordinate axes is at an angle half of the angle of a previous axis. Thus any number of axes can be rendered in the form of a graph. For example, a first coordinate axis may be located between and have an equal angular distant to a second and a third coordinate axis in the series of coordinates wherein the second coordinate axis in the series of coordinate axes is immediately previous to the first coordinate axis and the third coordinate axis is immediately previous to the second coordinate axis in the series of coordinate axes.

### BRIEF DESCRIPTION OF THE DRAWINGS

Implementations of the invention will become more apparent from the detailed description set forth below when taken in conjunction with the drawings, in which like elements bear like reference numerals:

FIG. 1 depicts a flow chart of an exemplary implementation of an inventive method for Folded Dimension Visualization;

FIG. 2 depicts a flow chart of an exemplary implementation of an inventive method for Least Square Clustering;

FIG. 3 depicts a flow chart of an exemplary implementation of an inventive method for selecting predictors;

FIG. 4 depicts a flow chart of an exemplary implementation of an inventive method for creating a solution space;

FIG. 5 depicts a flow chart of an exemplary implementation of an inventive method for creating a distance function;

FIG. 6 depicts a cluster generated from thermal emission spectra data using an exemplary implementation of an inventive method;

FIG. 7 depicts a cluster generated from thermal emission spectra data using an exemplary implementation;

FIG. 8 depicts a cluster generated from thermal emission spectra data using an exemplary implementation;

FIG. 9 depicts a cluster generated from thermal emission spectra data using an exemplary implementation;

FIG. 10 depicts a two dimensional rendering, which can printed out or rendered in an output computer graphic, of the coordinate system used for an exemplary implementation of an inventive method for Folded Dimension Visualization;

FIG. 11 depicts a two dimensional rendering, which can printed out or rendered in an output computer graphic, of a folded dimensional diagram created using an exemplary implementation of an inventive graphing method; and

FIG. 12 depicts a two dimensional rendering, which can printed out or rendered in an output computer graphic, as a folded dimensional diagram created using an exemplary implementation of an inventive graphing method.

### DETAILED DESCRIPTION

There is often a need for clustering but in comparison to a set of known objects. In one implementation a perspective wherein a set of predictor X variables creates a solution space where clustering distances are measured. It also combines notions of x and y variables in the model making them interchangeable.

The data being clustered can be represented in the solution space with reduced dimensions equal to the number of X predictor variables, the distances become more meaningful and the clustering results become more useful and indicative of valid groupings. Additionally the user can guide the clustering by selecting a number of predictors as reference data while clustering. The implementation also has the ability of clustering in separating the data into a flexible number of clusters. Moreover, any number of existing clustering algorithms can be used in conjunction with the implementation without changing the existing clustering algorithms' basic format because the implementation's foundation has a provable modeling method such as multiregression and other similar modeling techniques. Variations of the solution could be developed to adapt to many different problem sets. For example, ridge regression could be applied if multicolinearity exists in the data or factor analysis could be applied if underlying factors are sought.

An example of Least Square Clustering would be to cluster a large number of observed spectrometer readings with respect to spectra of five known minerals. An example of the Folded Dimensional Visualization would be creating a representative two-dimensional graph of hundreds of observed vectors with each vector having many dimensions. These methods can be applied to applications including but not limited to applications of data mining, machine learning, pattern recognition, data analysis, predictive analysis, grouping and categorization of various forms of data, bio-informatics, analyzing microarray genetic data, intelligent search engines and intelligent internet advertisements.

In one implementation, a user can apply domain knowledge and guide the clustering based on a known set of criteria. In the context of this disclosure, data is represented and manipulated in form of vectors and matrices. Vectors here will be denoted in bold.

Using a vector framework, a clustering distance function adheres to three general rules where V₁ and V₂ below are particular objects or vectors and Vi represents any i^{th} vector in the data set in relations below:

Distance[V₁,V₁]=0 (1)

Distance[V₁,Vi]>=0 (2)

Distance[V₁,V₂]=Distance[V₂,V₁] (3)

Additionally multiregression can also be applied to a set of vectors when attempting to find a best fit solution of vectors X for a given response vector y where ε is the error vector being minimized, β is the solution vector and X represents a matrix of vectors 1,x₁ to xₙ regressor or predictor vectors where 1 is an optional vector of all 1's to account for the intercept:

ε=y−βX (4)

or:

$$ɛ = [ \begin{matrix}{ɛ}_{1} \\ {ɛ}_{2} \\ … \\ {ɛ}_{m}\end{matrix} ] = [ \begin{matrix}{y}_{1} \\ {y}_{2} \\ … \\ {y}_{m}\end{matrix} ] - [ \begin{matrix}1 & {x}_{11} & … & {x}_{1 n} \\ 1 & {x}_{21} & … & {x}_{2 n} \\ … & … & … & … \\ 1 & {x}_{m 1} & … & {x}_{mn}\end{matrix} ] [ \begin{matrix}{β}_{1} \\ {β}_{2} \\ … \\ {β}_{n}\end{matrix} ] \qquad ( 5 )$$

### The matrix equation commonly used in solving is then β=(X′X)⁻¹X′y

Here, β can be viewed as the solution vector for a given y observation vector based on a set of n predictor x vectors in matrix X. For a vectorial proof of the above least-squares normal equation please refer to Section A.

It is noteworthy here that (X′X)⁻¹X′ does not depend on a given response vector y and it is derived solely through the vectors in matrix X. In order to compare two observations, dot product the β vectors of each by each other.

<β₁,β₂>. (6)

or in matrix notation it is transpose of β₁ multiplied by β₂:

β₁′β₂ (7)

Noting that [y₁′(X(X′X)⁻¹)]=β₁′, where β₁ is the beta vector for observation vector y₁ and [((X′X)⁻¹X′)y₂]=β₂, where β₂ is the beta vector for observation vector y₂ and substituting into equation (7) above yields:

[y₁′(X(X′X)⁻¹)][((X′X)⁻¹X′)y₂] (8)

The above inner product is a similarity measure and can be converted to a distance measure. This is done by changing it to:

[(y₁−y₂)′(X(X′X)⁻¹)][((X′X)⁻¹X′)(y₁−y₂)] (9)

The above equation 9 now follows the rules for a clustering distance function as defined in equations 1-3.

For a detailed derivation of the inner product please refer to Section B.

With respect to other methods such as factor analysis, structured equation models, and various optimization techniques the equivalent solution vector for that method can be used in place of β₁ and β₂. This approach will hold for any modeling method that produces a solution set of values or coefficients that can then be placed into a solution vector.

### Detail Algorithm

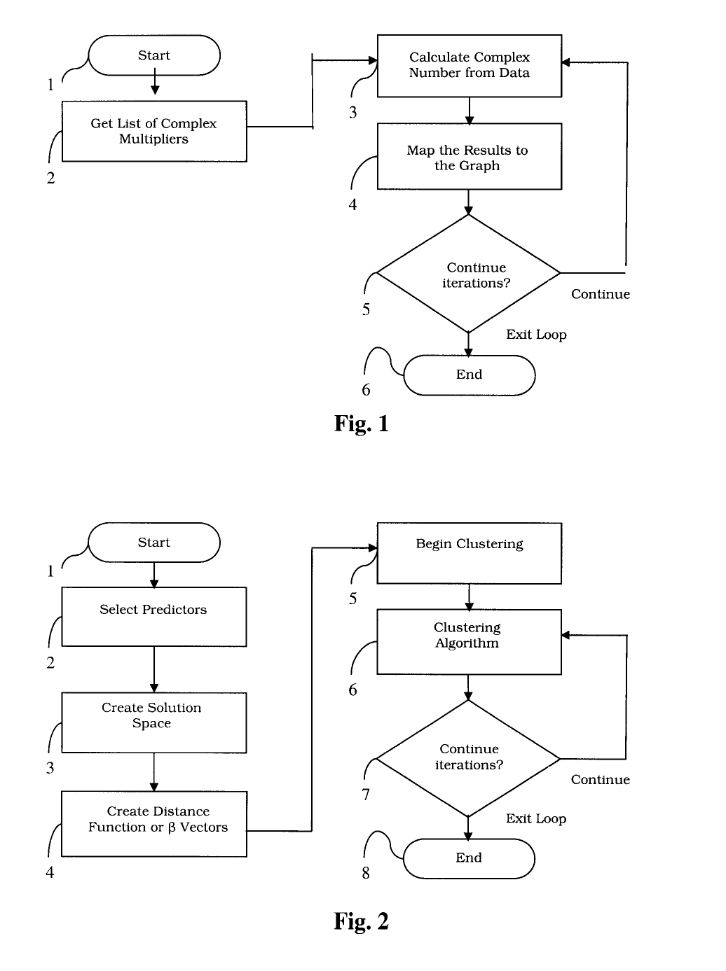

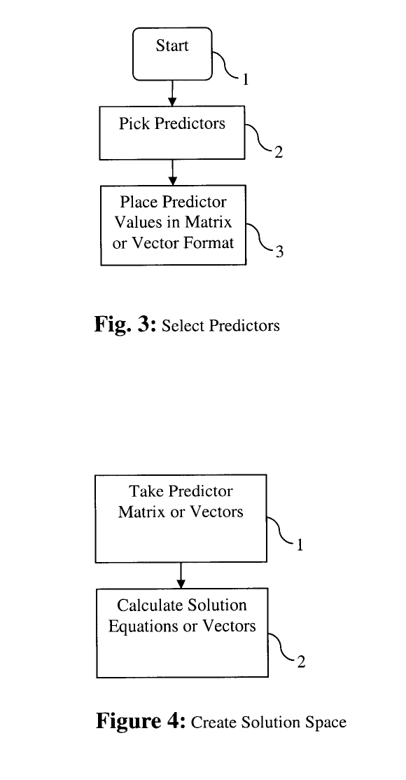

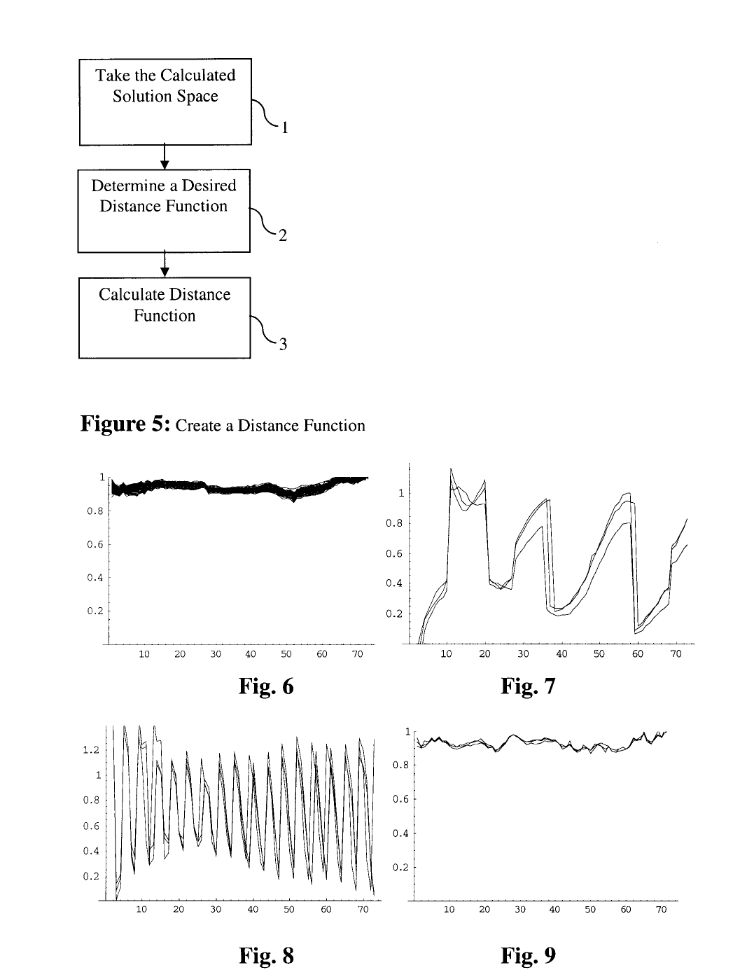

As per FIGS. 2 to 5, the following set of steps can summarizes the approach in one implementation:

### 1. Start of algorithm

### 2. Select a set of predictor or regressor vectors (for example, in an implementation, a set of seven baseline spectra signals can be placed into a matrix X=[x₁, x₂, X₃, X₄, X₅, X₆, X₇].

### 3. Create a solution space based on the regressors in step 2. For example calculate the solution to (X(X′X)⁻¹) and ((X′X)⁻¹X′) or just calculate the β solution vectors using any given method.

4. Create the distance function based on step 3. For example equation 9 could be defined as the distance formula or function. This is equivalent to creating a function that subtracts two vectors creating a delta vector from the differences between each given two objects being clustered, this delta vector is then transformed into a solution space through matrix or vector multiplications. Alternatively regression or another modeling technique can be used yielding the β solution vectors at this step.

### 5-8. Use one of many clustering algorithms to iterate through the data and generate the clusters using the above distance function or by clustering the β solution vectors directly.

In another implementation, the data representing the surface of the planet Mars may be analyzed. The orbiting TES (Thermal Emission Spectrometer) instrument captures 143 bands (70 of which are not used) with a 3 km spatial resolution utilizing a Michelson interferometer. The data equation for the analysis of a single observation is therefore a matrix of trial “n” (typically 10-20) minerals chosen at the time of analysis as the input columns by a reduced set of 73 bands (Bands 1 to 8, 36 to 64, 111 to 143 are commonly removed inclusively) as rows multiplied by a n-dimensional β column vector representing the unknown abundances with the results set equal to an observation response vector of 73 dimension as indicated. This is an over-determined system that can be solved using a best fit least square fitting or linear multi-regression. Since much of the surface data exhibits linear mixing, this has been used with great success in the analysis of the data. The extension of these methods into data mining techniques was the driving background through which the efforts for the current patent were formulated.

TES can be used to identify novel surface areas on Mars through an intelligent pattern recognition method. This is particularly useful since the amount of data collected is extremely large and characterizing a section of the surface can be a very time consuming task. However such finds are valuable and they can help influence future science objectives.

Using the methodology explained in this document, the distance function was applied to an agglomerative clustering function in Mathematica® using the “complete link” algorithm and applied to data from a 1 degree region surrounding the opportunity lander and Nili Fossae area. The clustering algorithm effectively grouped the data based on spectra of interest as defined by the X predictive vectors and some of the results are shown in FIGS. 6, 7, 8 and 9. The number of minerals of interest reduced the distance function to a dimensionally denser solution space. The number of predictors times two yielded a good grouping and in fact some unknown error spectra signals (not part of the X matrix) such as those generated by antenna transmissions while the probe was making an observation were successfully clustered together as shown in FIGS. 7 and 8 while a small number of novelty (or irregular) spectra was grouped together in the cluster shown in FIG. 9.

### Folded Dimensional Visualization

Referring now to FIG. 9, a means of visualizing many dimensions is presented. The primary dimension can be rendered as −1 on the left side of a unit circle diagram and a second dimension as i (or \sqrt{−1}) on the unit circle of a complex plane at the 90° point, then at the 45 degree point between 0 and i can be the third dimension and each subsequent dimension can be half the angle. This has a mathematical foundation since ‘i’ is the square root of (−1) and \sqrt{i} can be calculated as

$$( \frac{\sqrt{2}}{2} + \frac{\sqrt{2}}{2} i )$$

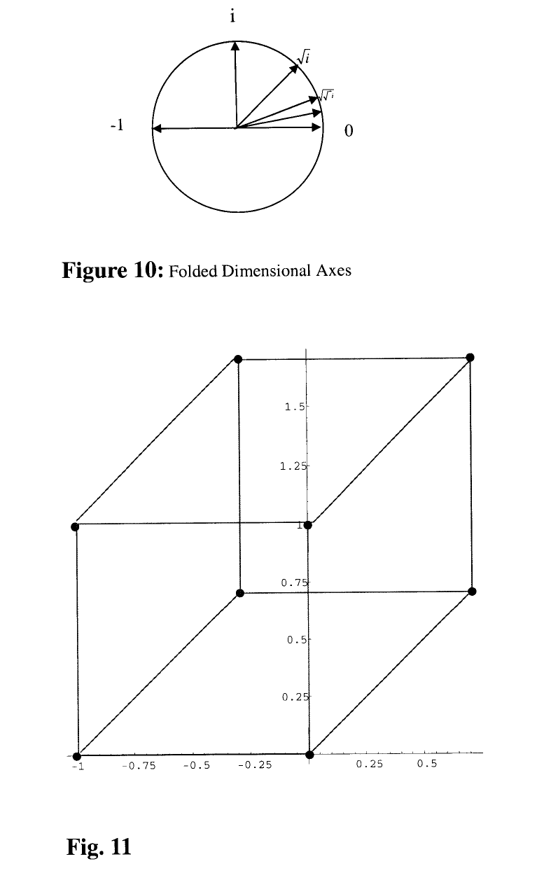

which falls at the 45 degree point between 0 and ‘i’ (see FIG. 10) and since each subsequent complex square root produces a new unit vector for the next dimension by halving or folding the angle in two each time. Therefore, to place any data point into the diagram, each component of the normalized vector can be multiplied respectively with −1, i, \sqrt{i}, . . . and so on and sum up the results into a single complex number that simply maps into the diagram with no calculations involved other than a multiplication and addition of the resulting complex numbers. Negative one (−1), as the first number used in the multiplication is can be considered to be a complex number (e.g., −1+0*i).

By way of illustration and not by limitation, vertex points of a three-dimensional cube can be rendered in a two-dimensional (planar representation) graphical representation of the cube with a vertex at the origin and all other vertices 1 unit apart. As described the cube vertices {x,y,z} in three dimensional space can be at {0,0,0}, {0,1,0}, {1,1,0}, {1,0,0}, {0,0,1}, {0,1,1}, {1,1,1}, and {1,0,1}. For each point the x term can be multiplied by (−1), the y value can be multiplied by i and the z component can be multiplied by

$$( \frac{\sqrt{2}}{2} + \frac{\sqrt{2}}{2} i )$$

which it equivalent to \sqrt{i} to get:

$$\{ 0 , 0 , 0 \} = > 0 , \{ 0 , 1 , 0 \} = > i , \{ 1 , 1 , 0 \} = > i - 1 , \{ 1 , 0 , 0 \} = > - 1 , \{ 0 , 0 , 1 \} = > ( \frac{\sqrt{2}}{2} + \frac{\sqrt{2}}{2} i ) , \{ 0 , 1 , 1 \} = > ( \frac{\sqrt{2}}{2} + \frac{2 + \sqrt{2}}{2} i ) , \{ 1 , 1 , 1 \} = > ( \frac{2 + \sqrt{2}}{2} + \frac{2 + \sqrt{2}}{2} i ) , \{ 1 , 0 , 1 \} = > ( \frac{2 + \sqrt{2}}{2} + \frac{\sqrt{2}}{2} i ) . \\$$

These can be calculated, replacing the i terms with the 90° or y direction to get the values: {0.,0.}, {0.,1.}, {−1.,1.}, {−1.,0.}, {0.707107,0.707107}, {0.707107,1.70711}, {−0.292893,1.70711}, {−0.292893,0.707107}.
Mapping these vertices to the complex plane and drawing lines between them can result in a rendering such as that shown in FIG. 11. Renderings can be printed on paper using a computer printer. Renderings can be output on a computer screen and in other electronic forms.

This implementation is not limited to three dimensional data, rather any number of dimensions can be rendered using an algorithm, for example. An example of the steps that can be included in the algorithm can be (e.g., refer to FIG. 1):
1. Obtain a data set;
2. Convert the data set into complex multipliers (e.g., the values: −1, i, \sqrt{i}, \sqrt{√i}, etc . . . )
3. For each point multiply each coordinate value by the appropriate element in the list and sum them up to get a single complex number for that point.
4. Map the points to a two dimensional graph with the real component as x and the imaginary component as y.
5. Continue until all the points are mapped.

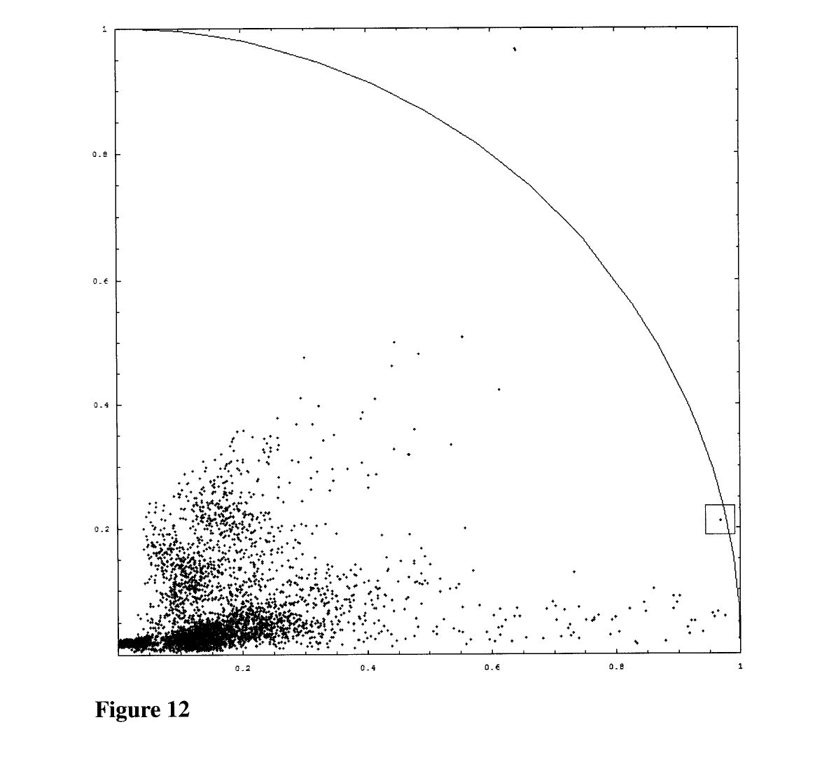

In another implementation of the aforementioned Folded Dimensional Visualization technique, spectra was gathered over a region of a planet, with each spectra a 73 dimension object. The spectra were graphed by first calculating the eigenvectors of the Gram matrix from the data and then by projecting the data into the resultant eigenvectors. The resulting rotated vectors were representative of the variance coordinates in order of greatest variance (e.g., Principal Components Analysis “PCA”). The resultant 73 dimensional rotated vectors were then graphed using this technique. In some instances the dominant three eigenvectors were removed from the graph, thereby displaying only the residual components. The results was a of the spectra that extended the traditional use of PCA by addressing its limitation—namely PCA is a good tool for finding the greatest axis of variance but valid data that is less common may get discarded as noise. Here data points that were valid and purely along a small axis of variance stand out as they will radiate out towards the edge of the graph and in a direction close to one of the folded angles (indicated in the boxed pixel in FIG. 12). This is a single spectra reading that is aligned with the fifth dimension along the ((((180/2)/2)/2)/2)=11.25 degree axis. With the first three dimensions removed this makes the data aligned to the 8^{th} eigenvector. Because it is radiating out to near the circle parameter and since all the data was normalized to unit length prior to analysis, this suggests a pure reading along that 8^{th} axis. In this manner, novel spectra can effectively be located through the graphical rendition. Hence massive amounts of data having multiple dimensions and the interactions between the dimensions can be examined using a single graph.

In this manner, multiple two dimensional renditions of the spectra can be compared visually and grouped based on a visible trait. For example, if data clusters in one quadrant of the planar graph, those renditions can be grouped together while those of another quadrant of the planar graph can be put in a different group or set.

Implementations allow for flexibility as such implementations allow various supplementary approaches to be easily incorporated into the solution. In one of the examples provided, ridge regression was also used at some point by changing the X matrix to [X+(I*k)] where I is the identity matrix and k is a constant set manually to create a biased ridge regression estimator.

The above examples are by way of illustration and not limitation. Numerous variations and modifications are easily applied given the flexibility of the implementations herein described to accommodate to various clustering and multivariate analysis algorithms. Moreover, implementations have applications in different fields such as bioinformatics, economics, marketing, internet search engines, and any other field in which data can be organized for meaningful analysis.

By way of example and not limitation, mathematical support for the above is provided in the following two sections.

### Section A

Since each single observation y is actually a vector and yᵢ does not represent independent rows of observations, a geometrical interpretation of Least Squares is applicable here.

Matrix and algebraic derivations are available in the literature [2,3,4,5,6], but a vector derivation will be useful for building a framework for further analysis methodologies.

For a system with n variables (reference minerals) and m bands, let's define the error vector ε as:

ε=y−(β₀1+β₁x₁+β₂x₂+ . . . +βₙxₙ) (1)

### Where:

$$y = [ \begin{matrix}{y}_{1} \\ {y}_{2} \\ … \\ {y}_{m}\end{matrix} ] , {x}_{i} = [ \begin{matrix}{x}_{1 i} \\ {x}_{2 i} \\ … \\ {x}_{m i}\end{matrix} ] , 1 = [ \begin{matrix}1 \\ 1 \\ … \\ 1\end{matrix} ] and ɛ = [ \begin{matrix}{ɛ}_{1} \\ {ɛ}_{2} \\ … \\ {ɛ}_{m}\end{matrix} ] \qquad ( 2 )$$

From a geometrical perspective, the squared length of the difference between the response vector and its projection into the space is minimized by the regressors:

∥ε∥²=ε·ε=(y−(β₀1+β₁x₁+β₂x₂+ . . . +βₙxₙ))·(y−(β₀1+β₁x₁+β₂x₂+ . . . +βₙxₙ)) (3)

The squared length represented by ε·ε here is equivalent to SSE (Sum of Squared Errors) usually found in statistics literature on Ordinary Least Squares. Using the chain rule on the dot product to differentiate ε·ε with respect to β:

$$\begin{matrix}\frac{\partial }{\partial {β}_{i}} ( ɛ \cdot ɛ ) = ( \frac{\partial }{\partial {β}_{i}} ɛ ) \cdot ɛ + ɛ \cdot ( \frac{\partial }{\partial {β}_{i}} ɛ ) \\ = ( 2 ) ɛ \cdot ( \frac{\partial }{\partial {β}_{i}} ɛ )\end{matrix}$$

### Where from (1):

$$\frac{\partial }{\partial {β}_{i}} ɛ = \frac{\partial }{\partial {β}_{i}} ( y - ( {β}_{0} 1 + {β}_{1} {x}_{1} + {β}_{2} {x}_{2} + … + {β}_{n} {x}_{n} ) ) = - {x}_{i}$$

### Therefore for each βᵢ is

$$\frac{\partial }{\partial {β}_{i}} ( ɛ \cdot ɛ ) = ( - 2 ) {x}_{i} \cdot ɛ$$

Resulting below relations with a vector of 1's for the intercept and xᵢ for each of the regressors:

$$[ \begin{matrix}( - 2 ) 1 \cdot ɛ \\ ( - 2 ) {x}_{1} \cdot ɛ \\ … \\ ( - 2 ) {x}_{n} \cdot ɛ\end{matrix} ]$$

Setting the above derivatives of ε·ε to zero minimizes the function and results the below dot product relationships:

$$[ \begin{matrix}1 \cdot ɛ \\ {x}_{1} \cdot ɛ \\ … \\ {x}_{n} \cdot ɛ\end{matrix} ] = [ \begin{matrix}0 \\ 0 \\ … \\ 0\end{matrix} ] \qquad ( 4 )$$

These equations indicate an orthogonal relationship will exist between the error vector ε and each of the regressors xᵢ. This conforms to geometrical interpretations of Least Squares in relevant text references.

The dot products can now be converted to the matrix multiplication below:

$$[ \begin{matrix}1 … {1}_{m} \\ {x}_{11} … {x}_{m 1} \\ … \\ {x}_{1 n} … {x}_{mn}\end{matrix} ] [ \begin{matrix}{ɛ}_{1} \\ {ɛ}_{2} \\ … \\ {ɛ}_{m}\end{matrix} ] = [ \begin{matrix}0 \\ 0 \\ … \\ 0\end{matrix} ] \qquad ( 5 )$$

If X represents the matrix of regressors then equation (5) becomes X′ε=0 and equation (1) becomes ε=y−Xβ. Substituting ε from (1) into (5) can get X′(y−Xβ)=0. This yields X′y=X′Xβ and solving for β will result the familiar multiregression equations:

β=(X′X)⁻¹X′y (6)

It is important to note that the vector of 1's is useful here as it compensates for signal adjustments not related to the regressors. For example this could include sun angle effects for each observation if applied to infrared spectra data.

### Section B

Inner products can be used in measuring a distance. A generalized inner product can be defined as a function on pairs of vectors such that the properties of symmetry (x′y=y′x), positivity (x′x≧0 and x′x=0 if and only if x=0) and bilinearity (for all real numbers a and b, (ax+by)′z=ax′z+by′z for all vectors x, y and z) are preserved. Thus a new inner product can be defined such that given a regressor vector from the X matrix (xₖ) and an observation y it should return the solution coefficient for that vector βₖ.

For example given the X matrix of all the regressors the below inner product should yield the abundance β₁ for an observation vector y and a particular lab spectra x₁:

<y,x₁>=β₁

If this was an orthogonal system the Euclidean inner product would be sufficient. However, an oblique or “least square” inner product is needed in our solution.

This oblique inner product can be obtained as follows:

Where xₖ is the k^{th} predictor or regressor vector and ûₖ is the unit vector for the k^{th} dimension (example: k=3 would give û₃=<0,0,1,0,0, . . . >) and X is the matrix of all predictors, then the k^{th} regressor can be obtained as:

xₖ=ûₖ′X′

It follows that:

xₖ′X=ûₖ′X′X

### Swapping the sides of the equation and multiplying by (X′X)⁻¹ yields:

ûₖ′(X′X)(X′X)⁻¹=xₖ′X(X′X)⁻¹

ûₖ′=xₖ′X(X′X)⁻¹

from Section A:

β=(X′X)⁻¹X′y

We then get:

βₖ=ûₖ′β=xₖ′X(X′X)⁻¹(X′X)⁻¹X′y

This creates an inner product in the solution space and if xₖ and y are replaced with two observations y₁ and y₂ it is equivalent to β₁′β₂.

Note that since [y₁′(X(X′X)⁻¹)]=β₁′, where β₁ is the beta vector for observation vector y₁ and [((X′X)⁻¹X′)y₂]=β₂, where β₂ is the beta vector for observation vector y₂ then substituting into equation β₁′β₂ above also yields:

[y₁′(X(X′X)⁻¹)][((X′X)⁻¹X′)y₂]

This is a similarity measure to get a distance measure simply change the function to:

[(y₁₋y₂)′(X(X′X)⁻¹)][((X′X)⁻¹X′)(y₁₋y₂)] (1)

This can be also thought of as (y₁₋y₂)′Q(y₁₋y₂) with Q as a matrix formed from all the X. Although this approach would also result the same distance calculation, it is more computationally resource intensive than (1). All this demonstrates the fact that a least square distance function can be defined based purely on the X matrix and two observations y₁ and y₂. Since (1) is equivalent to (β₁₋β₂)′(β₁₋β₂), to improve the performance yet further simply cluster the solution vectors and the distance function is not needed. To decrease the time complexity order of this method the solution vectors should first be computed using regression as a first step. Then the resultant β vectors can be simply clustered as a second step. This reduces the time complexity order of the method purely to that of performing a regression and a standard clustering.

The present invention may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A method comprising:
receiving an input variable having multiple dimensions in a first coordinate system;
using an algorithm to convert the input variable from the first coordinate system to a second coordinate system; and
rendering a two-dimensional visual representation of the input variable using the second coordinate system, wherein the second coordinate system has a series of coordinate axes in a single plane each located at a corresponding predetermined angle away from each of the other coordinate axes of the second coordinate system.

2. The method as defined in claim 1, wherein the algorithm to convert the input variable includes multiplying each coordinate of the input variable by a complex number.

3. The method as defined in claim 2, wherein the complex number that is used to multiply the first dimension of the input variable is the number negative one.

4. The method as defined in claim 1, wherein the series of coordinate axes includes:
a first coordinate axis in a plane;
a second coordinate axis in the plane that is located at one of the corresponding predetermined angles away from the first coordinate axis; and
a third coordinate axis in the plane that is located at half the value of the one of the corresponding predetermined angles away from the second coordinate axis.

5. The method as defined in claim 1, wherein a first coordinate in the series of coordinate axes is forty-five degrees away from a second coordinate axis in the series of coordinates axes and the second coordinate axis in the series of coordinate axes is immediately previous to the first coordinate axis.

6. The method as defined in claim 1, wherein:
each coordinate axis in the series of coordinate axes is each located in a single plane;
each coordinate axis in the series of coordinate axes is each located at the corresponding predetermined angle away from the previous coordinate axis;
each subsequent corresponding predetermined angle is equal to half the angular distance of the immediately previous corresponding predetermined angle.

7. The method as defined in claim 6, wherein the first corresponding angle is about ninety degrees.

8. The method as defined in claim 1, further comprising:
applying a second algorithm to the input variable, wherein each of the dimensions of the input variable is grouped based on a trait.

9. A method for detecting variations in a spectra signal, comprising:
using an algorithm to convert the spectra signal from the first coordinate system to a second coordinate system;
rendering a two-dimensional visual representation of the spectra signal using the second coordinate system, wherein the second coordinate system has a series of coordinate axes in a single plane each located at a corresponding predetermined angle away from each of the other coordinate axes of the second coordinate system;
comparing each two-dimensional visual representation for each of the corresponding spectra signal with each other; and
grouping each two-dimensional visual representation for each of the corresponding spectra signal into a plurality of set of two-dimensional visual representation based on a common visual characteristics.
